(19) United States
(12) Patent Application Publication
(10) Pub. No.: US 2024/0009650 A1
(43) Pub. Date: Jan. 11, 2024

(54) ABSORBENT AND BIODEGRADABLE MATERIAL

(71) Applicant: Brice Patrick MURPHY, Round Rock, TX (US)

(72) Inventor: Brice Patrick MURPHY, Round Rock, TX (US)

(21) Appl. No.: 18/219,476

(22) Filed: Jul. 7, 2023

Related U.S. Application Data
(60) Provisional application No. 63/388,227, filed on Jul. 11, 2022.

(51) Int. Cl. B01J 20/24; B01J 20/12; A01K 1/015

(52) U.S. Cl. CPC B01J 20/24; B01J 20/12; A01K 1/0154; A01K 1/0155

(57) ABSTRACT

An absorbent material may include glucomannan and biodegradable and/or non-biodegradable additives/base material. The biodegradable additives may be corn, walnut shells, newspaper, grass, wood chips, x-DDGs, and the like.

### CROSS-REFERENCES TO RELATED APPLICATIONS

This application claims the benefit of U.S. Provisional Patent Application No. 63/388,227, filed Jul. 11, 2022, the entire content of which is herein incorporated by reference.

### STATEMENT REGARDING FEDERALLY SPONSORED RESEARCH OR DEVELOPMENT

(NOT APPLICABLE)

### BACKGROUND

The embodiments described herein relate generally to absorbent materials and, more particularly, to an absorbent and biodegradable material designed to absorb substances in solid, liquid, gas, or combination phases.

Numerous products require the need for absorbent materials. Such products include cat litter, diapers, hospital solidifiers, and the like. The largest selling and most effective absorbent material is sodium polyacrylate, which is not biodegradable. Another frequently used material is clay, which must be mined. Each of these materials is filling landfills.

Therefore, there is a need for a material that is both absorbent and biodegradable to provide for absorbing substances in all phases without continuing to fill landfills.

Conventional clay-based litter is typically made of granules of smectite, typically smectite or swelling clay(s), like bentonite clay(s), which frequently includes other components like calcium carbonate, silica, fragrances or scents, and odor controllers. While many attempts have been made in the past to produce lighter weight clay-based litter having bulk densities less than 40 pounds per cubic feet, these attempts have had limited success. Quite often litter performance is either adversely impacted or the weight reduction not all that significant.

While many attempts to produce lighter weight clay-based litter by adding lighter weight components are limited by the fact that such litters still require at least 70% swelling clays, typically bentonite, to still perform adequately as litter.

### SUMMARY

Some embodiments of the present disclosure include an absorbent and biodegradable material. The material may include glucomannan and biodegradable and/or non-biodegradable additives. The biodegradable additives may be corn, walnut shells, newspaper, grass, wood chips, and the like.

In an exemplary embodiment, an absorbent material includes 1-99% by weight glucomannan and biodegradable and/or non-biodegradable additives. The material may include 5-25% by weight of the glucomannan and 75-95% by weight of the biodegradable additives. The material may include at least 6% or 6-12% by weight of the glucomannan.

In some embodiments, the biodegradable additives are selected from corn cobs, walnut shells, newspaper, grass, wood chips, cedar pine, corn pulp, and x-DDGs.

An amount of glucomannan may be selected to absorb one of water, oil, gas, blood, bodily fluids, urine, hazardous waste, hazardous materials, moisture in air, other volatiles in the air, and feces. In this context, the amount of glucomannan may be further selected for a specific application including one of a hospital grade solidifier, cat litter, diaper material, with buried cables, in above ground storage tanks, in bedpans, to treat oil spills, as rodent bedding, as poultry/livestock bedding, in zoo applications, in farming applications, and in compost toilets for recreational vehicles.

The biodegradable additives may include at least one of fragrances, odor reducers, and ammonia neutralizers.

In another exemplary embodiment, a composition for absorbing fluids includes a base material that is organic or inorganic and 1-99% by weight glucomannan. The composition may be suitable for use as cat litter.

In yet another exemplary embodiment, a method of manufacturing a composition for absorbing fluids includes the steps of mixing a base material that is organic or inorganic with 1-99% by weight glucomannan. The base material may be one of clay, walnut shells, wheat, and x-DDGs, where the mixing step includes mixing the base material with at least 6% by weight of the glucomannan. The mixing step may be practiced by at least one of stirring, shaking, blending, and coating.

### BRIEF DESCRIPTION OF THE DRAWINGS

These and other aspects and advantages will be described in detail with reference to the accompanying drawings, in which:

FIG. 1 shows test results in a composition using glucomannan with clay;

FIG. 2 shows test results in a composition using glucomannan with walnut shells;

FIG. 3 shows test results in a composition using glucomannan with wheat; and

FIGS. 4 and 5 show test results using cat urine in a composition using glucomannan with clay.

### DETAILED DESCRIPTION

In the following detailed description, numerous details, examples, and embodiments of the invention are described. However, it will be clear and apparent to those skilled in the art that the invention is not limited to the embodiments set forth and that the invention can be adapted for any of several applications.

The composition of the present disclosure may be used as an absorbent material and may comprise the elements described below. This list of possible constituent elements is intended to be exemplary only, and it is not intended that this list be used to limit the composition of the present application to just these elements. Persons having ordinary skill in the art relevant to the present disclosure may understand there to be equivalent elements that may be substituted within the present disclosure without changing the essential function or operation of the composition.

The various elements of the composition of the described embodiments may be related in the described exemplary fashion. It is not intended to limit the scope or nature of the relationships between the various elements and the following examples are presented as illustrative examples only.

By way of example, some embodiments include an absorbent and biodegradable material comprising glucomannan and a base material or additives, wherein the base material/additives are also biodegradable and may include, for example, corn (cob), walnut shells, newspaper, grass, wood chips, cedar pine, corn pulp, and the like. The additives may also include inorganic materials, such as sodium polyacrylate. In some embodiments, the material may also include non-biodegradable additives. In yet further embodiments, the additives may also include fragrances, odor reducers, ammonia neutralizers, and others. Another exemplary base material/additive is DDG (dried distiller grains) or x-DDG. DDGs are leftovers after corn kernels are used to produce ethanol, and x-DDGs are DDGs that, after being used for ethanol production, are treated with one or more solvents to extract any potentially useful natural compounds that remain. In embodiments, the material may be designed to absorb substances in solid, liquid, gas, or combination phases.

The additives may be added to the material for a variety of purposes, which may be specific to the application of the material. For example, the additives may be added for the following purposes: non-stick, clumping, neutralizing smell, being flushable in public sewage or in a septic tank, compostable, or as a fertilizer.

In embodiments, the material may comprise from about 1 to about 99% by weight glucomannan. More specifically, a particular embodiment may comprise about 75 to about 95% by weight additive and about 5 to about 25% by weight glucomannan.

Glucomannan is made from the konjac plant, is biodegradable, and can absorb up to 50 times its weight. For example, when used in a cat litter, 10 grams of glucomannan may absorb 1.5 ounces of liquid. In contrast, an existing clay cat litter requires 100 grams of clay to absorb 1.5 ounces of liquid. As such, glucomannan is a more effective absorbent than clay, and it is biodegradable, unlike clay. This is supported by the data from the following examples.

Example 1 (Walnut Shells and Glucomannan): To show improvements over existing organic cat litter, the absorbent properties of a composition were tested. First, 100% organic walnut shells were tested. An amount of 44 grams/1.55 oz. of water simulating one cat urinating was poured onto the walnut shells, and clumping behavior was observed. Specifically, it was noted what amount of walnut shells was required (in grams) to remove the 44 grams of water. Then, compositions with different percentages of glucomannan with the walnut shells were created. Specifically, the compositions included 90% walnut shells and 10% glucomannan, 75% walnut shells and 25% glucomannan, 50% walnut shells and 50% glucomannan, and 100% glucomannan.

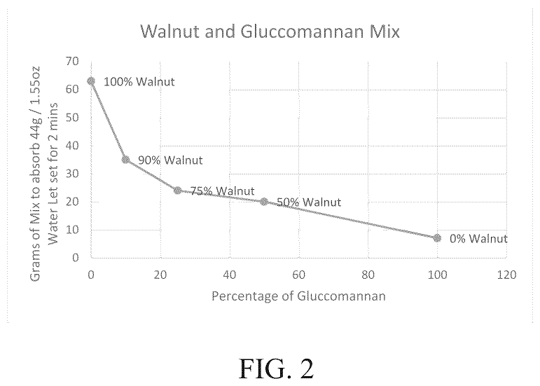

It was observed that 100% walnut shells resulted in very poor clumping, and 63 g of the material was required to remove the 44 g of water. The walnut shells also stuck to the container. It was also observed that 100% glucomannan only required 7 g of the glucomannan to remove the 44 g of water and provide a perfect clump, which was easily removed all in one piece from the container without sticking to the sides of the container. When the composition included 10% glucomannan and 90% walnut shells, 35 g of the material was required to remove the 44 g of water. Again, the material was easily removed in one perfect clump with no sticking to the container, and the water never penetrated the material more than a few millimeters. The data is presented in FIG. 2 and shown below in Table 1:

| | | | Grams of mix to absorb |
|---|---|---|---|
| | | | 44 g/1.55 oz |
| | Walnut | Glucomannan | water let set for 2 mins |
| 100% Walnut | 100 | 0 | 63 |
| 90% Walnut | 90 | 10 | 35 |
| 75% Walnut | 75 | 25 | 24 |
| 50% Walnut | 50 | 50 | 20 |
| 0% Walnut | 0 | 100 | 7 |

As such, by adding glucomannan to the material, the amount of walnut shells could be reduced dramatically, reducing overall weight of the material while still providing a perfect clump and while keeping the container holding the material clean. In fact, at 90% walnut shells and 10% glucomannan, the mixture was almost twice as effective as walnut shells alone.

Example 2 (Clay and Glucomannan): The absorbent properties of a composition were tested. First, 100% clay was tested. The same amount of 44 grams/1.55 oz. of water simulating one cat urinating was poured onto the clay, and clumping behavior was observed. Specifically, it was noted what amount of clay was required (in grams) to remove the 44 grams of water. Then, compositions with different percentages of glucomannan with the clay were created. Specifically, the compositions included 90% clay and 10% glucomannan, 75% clay and 25% glucomannan, and 100% glucomannan.

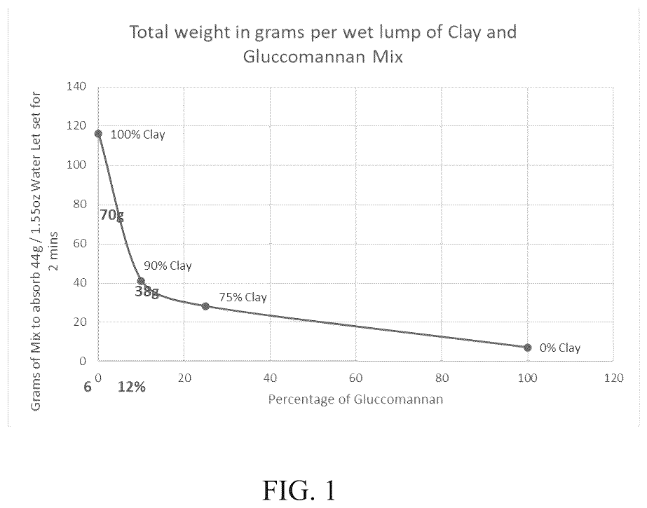

It was observed that 100% clay resulted in very poor clumping, and 116 g of the material was required to remove the 44 g of water. It was also observed that 100% glucomannan only required 7 g of the glucomannan to remove the 44 g of water and provide a perfect clump, which was easily removed all in one piece from the container without sticking to the sides of the container. When the composition included 10% glucomannan and 90% clay, 41 g of the material was required to remove the 44 g of water. The data is presented in FIG. 1 and shown below in Table 2:

| | | | Grams of mix to absorb |
|---|---|---|---|
| | | | 44 g/1.55 oz |
| | Clay | Glucomannan | water let set for 2 mins |
| 100% Clay | 100 | 0 | 116 |
| 90% Clay | 90 | 10 | 41 |
| 75% Clay | 75 | 25 | 28 |
| 0% Clay | 0 | 100 | 7 |

By adding glucomannan to the material, the amount of clay could be reduced dramatically, reducing overall weight of the material while still providing a perfect clump and while keeping the container holding the material clean. In fact, at 90% clay and 10% glucomannan, the mixture was more than twice as effective as clay alone.

With continued reference to FIG. 1, the test results show a much greater effect of the glucomannan in the lower percentages by weight. That is, from the test results shown in FIG. 1, it appears that an optimum composition may include between 6-12% of glucomannan by weight mixed with clay. At 6%, 70 g of clay were required to absorb the 44 g of water, resulting in 42% savings of clay. With 12% glucomannan added in the composition, 38 g of clay were required to absorb the 44 g of water, resulting in 68% savings of clay.

Still additional advantageous results were observed with the use of glucomannan in the 6-12% by weight range. For example, it was observed that the resulting clumps were smaller and flatter and closer to the surface for easy removal. Additionally, the cat urine did not reach the bottom of the litter box, thus avoiding additional mess requiring cleaning. The clumps also can be readily disposed of in a personal compost or flushed.

Example 3 (Wheat and Glucomannan): The absorbent properties of a composition were tested. First, 100% wheat was tested. The same amount of 44 grams/1.55 oz. of water simulating one cat urinating was poured onto the wheat, and clumping behavior was observed. Specifically, it was noted what amount of wheat was required (in grams) to remove the 44 grams of water. Then, compositions with different percentages of glucomannan with the wheat were created. Specifically, the compositions included 90% wheat and 10% glucomannan, 75% wheat and 25% glucomannan, 50% wheat and 50% glucomannan, and 100% glucomannan.

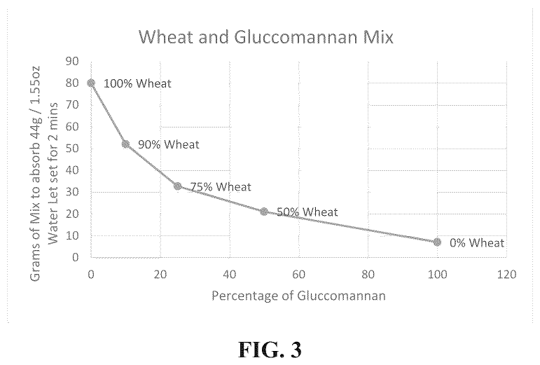

It was observed that 100% wheat resulted in very poor clumping, and 80 g of the material was required to remove the 44 g of water. It was also observed that 100% glucomannan only required 7 g of the glucomannan to remove the 44 g of water and provide a perfect clump, which was easily removed all in one piece from the container without sticking to the sides of the container. When the composition included 10% glucomannan and 90% wheat, 52 g of the material was required to remove the 44 g of water. The data is presented in FIG. 3 and shown below in Table 3:

| | | | Grams of mix to absorb |
|---|---|---|---|
| | | | 44 g/1.55 oz |
| | Wheat | Glucomannan | water let set for 2 mins |
| 100% Wheat | 100 | 0 | 80 |
| 90% Wheat | 90 | 10 | 52 |
| 75% Wheat | 75 | 25 | 32.7 |
| 50% Wheat | 50 | 50 | 21 |
| 0% Wheat | 0 | 100 | 7 |

By adding glucomannan to the material, the amount of wheat could be reduced dramatically, reducing overall weight of the material while still providing a perfect clump and while keeping the container holding the material clean. In fact, at 75% wheat and 25% glucomannan, the mixture was more than twice as effective as wheat alone.

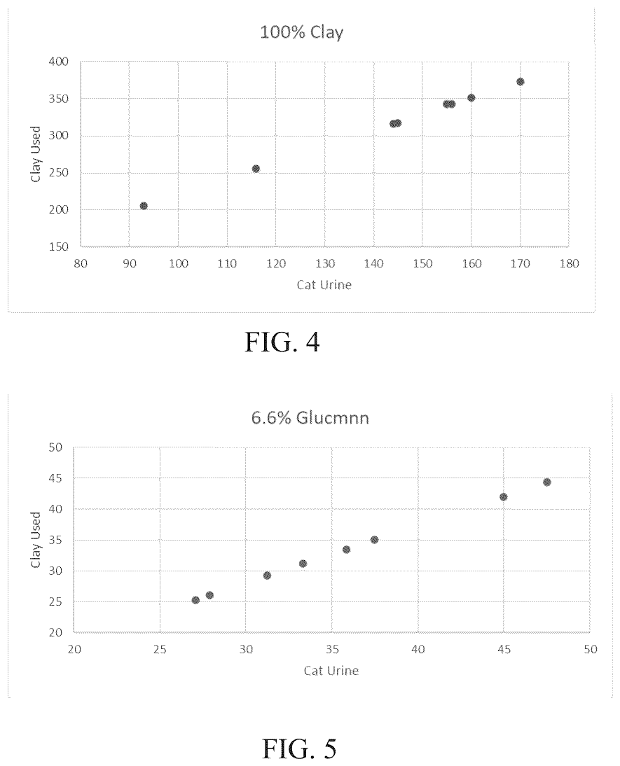

FIGS. 4 and 5 show test results using cat urine instead of water. The results generally align with those from the tests using water. FIG. 4 documents eight days of cat urine, where two cats averaged 3.75 urinations per day versus the weight of clay used to absorb the urinations with a 100% clay composition. The results show 83.3 g of 100% clay needed to absorb 1 cat urination. FIG. 5 shows the amount of clay and 6.6% glucomannan used to process eight cat urination clumps. With the composition including 6.6% glucomannan, 49 g of clay were required to absorb each cat urination, resulting in about 41% clay savings.

Glucomannan may be in the form of a powder that can be mixed or blended with a selected material (e.g., clay, walnut shells, wheat, etc. as discussed above).

Glucomannan is soluble in water, and in some embodiments, a glucomannan “spray” can be derived and sprayed directly on existing cat litter products. It has been discovered that the treated cat litter provides better absorbency and utilizes less clay or other cat litter base material for effective clump formation.

In another exemplary application, a fabric material infused with glucomannan can be added at the bottom of the litter box to prevent cat urine on existing cat litter to reach the bottom of the letter box.

To manufacture the material of the present disclosure, glucomannan would be mixed with the additives at a percentage that may vary depending on the additives used and the end use of the material. The composition can include the base material (e.g., clay, corn, wheat, etc.) and formed into pellets, or in powder. In some embodiments, the glucomannan may be mixed before or after the pellets are made. Pellets can be made using known pellet-making machinery. The product can be packaged for customers to mix themselves with an existing absorbent (e.g., cat litter). Glucomannan could also be put into a solution to be then coated on the base material.

Any known manufacturing methods may be utilized to arrive at the described composition of materials. Exemplary methods are described in U.S. Pat. Nos. 11,457,605, 9,266,089, Spanish patent ES2808666T3, Chinese patent CN109329078B, Chinese patent CN104837337B, and U.S. Pat. No. 10,470,433, the contents of which are hereby incorporated by reference.

In respect of density and mesh size, exemplary suitable parameters are described in PCT International Publication WO1998054956A1, the contents of which are hereby incorporated by reference.

The material may be used to absorb, for example, water, oil, gas, blood, bodily fluids, urine, hazardous waste, hazardous materials, moisture in air, other volatiles in the air, feces, and the like. The absorbent material may then be used in various applications, including as a hospital grade solidifier, cat litter, diaper material, with buried cables, in above ground storage tanks, in bedpans, to treat oil spills, as rodent bedding, as chicken/livestock bedding, in zoo applications, in farming applications, in compost toilets for campers and RV vans, and the like.

In the case of diapers and bedpans, the material may function to absorb urine and feces while reducing odor. For cat litter, the material may absorb urine and feces in litter boxes or the like, while helping to attract cats to the litter box and reduce odor. With respect to being a hospital waste solidifier, the material may be a powder that can turn liquid medical waste into a gel-like substance while reducing odor. When used in buried cables and above ground storage tanks, the material may absorb unwanted liquids. In some embodiments, the material may be designed to be added to an existing absorbent, such as cat litter, or it may be designed to be used alone as an absorbent.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An absorbent material comprising:
1-99% by weight glucomannan; and
at least one of biodegradable and non-biodegradable additives.

2. A material according to claim 1, comprising 5-25% by weight of the glucomannan and 75-95% by weight of the biodegradable additives.

3. A material according to claim 1, comprising at least 6% by weight of the glucomannan.

4. A material according to claim 3, comprising 6-12% by weight of the glucomannan.

5. A material according to claim 1, wherein the biodegradable additives are selected from corn cobs, walnut shells, newspaper, grass, wood chips, cedar pine, corn pulp, and x-DDGs.

6. A material according to claim 1, further comprising non-biodegradable additives.

7. A material according to claim 1, wherein an amount of glucomannan is selected to absorb one of water, oil, gas, blood, bodily fluids, urine, hazardous waste, hazardous materials, moisture in air, other volatiles in the air, and feces.

8. A material according to claim 7, wherein the amount of glucomannan is further selected for a specific application including one of a hospital grade solidifier, cat litter, diaper material, with buried cables, in above ground storage tanks, in bedpans, to treat oil spills, as rodent bedding, as poultry/livestock bedding, in zoo applications, in farming applications, and in compost toilets for recreational vehicles.

9. A material according to claim 1, wherein the biodegradable additives include at least one of fragrances, odor reducers, and ammonia neutralizers.

10. A composition for absorbing fluids comprising:
a base material that is organic or inorganic; and
1-99% by weight glucomannan.

11. A composition according to claim 10, wherein the base material comprises one of clay, walnut shells, wheat, and x-DDGs.

12. A composition according to claim 10, comprising 5-25% by weight of the glucomannan and 75-95% by weight of the base material.

13. A composition according to claim 12, used for cat litter.

14. A composition according to claim 10, comprising at least 6% by weight of the glucomannan.

15. A composition according to claim 14, comprising 6-12% by weight of the glucomannan.

16. A composition according to claim 14, used for cat litter.

17. A method of manufacturing a composition for absorbing fluids, the method comprising mixing a base material that is organic or inorganic with 1-99% by weight glucomannan.

18. A method according to claim 17, wherein the base material comprises one of clay, walnut shells, wheat, and x-DDGs, and wherein the mixing step comprises mixing the base material with at least 6% by weight of the glucomannan.

19. A method according to claim 18, wherein the mixing step comprises at least one of stirring, shaking, blending, and coating.

20. A method according to claim 17, wherein the mixing step comprises at least one of stirring, shaking, blending, and coating.
